(19) United States
(12) Patent Application Publication
(10) Pub. No.: US 2018/0345513 A1
(43) Pub. Date: Dec. 6, 2018

(54) ANNULAR KNIFE WITH A SENSOR FOR MEASURING THE CUTTING DEPTH OF A ROTATING KNIFE BLADE

(71) Applicant: Teknologisk Institut, Taastrup (DK)

(72) Inventor: Lars Bager Christensen, Taastrup (DK)

(21) Appl. No.: 15/778,401

(22) PCT Filed: Nov. 23, 2016
(86) PCT No.: PCT/EP2016/078553

§ 371 Date: May 23, 2018

(30) Foreign Application Priority Data
Nov. 23, 2015 (DK) PA 2015 00748

(51) Int. Cl. B26B 25/00; A22B 5/16

(52) U.S. Cl. CPC B26B 25/002; A22B 5/0064; A22B 5/165

(57) ABSTRACT

The disclosure relates to an annular knife with a sensor for determining the cutting depth and a method for determining the cutting depth. When trimming meat such as at abattoirs a customer may require a fat layer of a given thickness, however the natural fat layer of animals vat between different carcasses and within the individual carcass/meat piece. By determining the fat layer thickness and variation hereof of a meat piece before trimming the meat piece an operator may be presented with such information and be able to remove tit in different areas to obtain the required thickness. The trimming may be performed with a system calculating in real unit how much fat is to be removed when some fat has already been removed by an operator.

### CROSS-REFERENCE TO RELATED APPLICATIONS

The present application is a 371 national stage entry of PCT/EP2016/078553, filed 23 Nov. 2016 by the present Applicant, and entitled “ANNULAR KNIFE WITH A SENSOR FOR MEASURING THE CUTTING DEPTH OF A ROTATING KNIFE BLADE”. The present application additionally claims the benefit of Danish patent application PA 2015 00748, filed 23 Nov. 2015 by the present Applicant, and entitled “CIRKULAER KNIV SENSOR TIL MALING AF SKAEREDYBDE AF ET ROTERENDE KNIVSIALAD”.

### BACKGROUND

The disclosure concerns an annular knife or a circular knife with a sensor for determining the cutting depth of a rotating knife blade such as a Whizard knife or a rotating knife used for trimming meat e.g. at slaughterhouses, such as a Whizard Trimmer from Bettcher Industries. The disclosure also concerns a method for determining the cutting depth of a rotating knife and a system for performing trimming of meat pieces

### DESCRIPTION OF RELATED ART

Livestock carcasses or meat pieces hereof are often trimmed by removing skin and/or fat to obtain a meat piece with a pre-determined appearance and/or to remove part of a fat layer. At least part of this trimming is often performed manually where an operator removes visible skin parts from the meat and trims the fat layer where the fat layer seems to be thicker than a recipe for the product indicates. Trimming meat is often performed using an annular knife and is based on the visual appearance of the meat piece according to visible skin sections and sections where the operator can see and/or has experience of a too thick fat layer. However, as biological variation exists between individual animals, similar meat pieces from animals raised together may vary e.g. according to the thickness of fat. An operator may thus remove too much or too little fat from a meat piece. By such a manual trimming of meat pieces the final thickness of the fat layer may vary along each meat piece and among meat pieces and may be too thin or too thick according to the determined fat thickness, resulting in variation from the determined appearance/quality of the product and thus a lower price of the product.

A rotating knife such as an annular knife can (is usually) equipped with a solid contact area (termed a guide) in the form of a circular plate or a circular ring located within the circular (annular) rotating knife blade. The distance or position of the solid contact area in relation to the rotating blade is fixed. By angling the knife in relation to the cutting plane it is possible to cut with different depths into the item.

The guide, which may be a depth gauge, makes it easy for an operator to remove thin strips of e.g. fat or strips which each on a rough estimate has a fixed thickness and where the thickness is based on the operator's guess and experience according to determination of the thickness of the removed strips. The remaining fat layer on a meat piece may be too thin or too thick according to the requested thickness of a fat layer. However, it's the best the operator can do when keeping up the required speed of trimming the meat pieces.

The present disclosure relaxes to an annular knife with a sensor making it possible e.g. in real time to determine the thickness of removed skin/fat and thus to calculate the thickness of the fat layer being present on a meat piece while an operator is handling the meat piece, hereby the operator is informed if inure fat should be removed from the meat piece.

Removal of fat from a meat piece improves the product yield and the appearance of the meat.

### SUMMARY

Disclosed is a knife with an annular knife blade and a sensor capable of determining the position of the knife in space and the angling of the knife hereby making it possible to determine the cutting depth of the knife as the cutting depth is a function of the angling of the knife. By communication data such as position and angling of knife and/or cutting depth to a processor a cutting process can be analyzed in real time, this may be a trimming process removing skin and/or fat from animal meat pieces or removing skin from a human donor and/or patient.

The disclosure relates to an annular knife comprising at least

a) an annular knife holder,

b) an annular knife blade,

c) a handle or a robot connection unit, and

d) at least one orientation sensor.

The sensor of the knife may be mounted at the knife's solid parts, such as within the handle or within a frame protecting the sensor from exposure to e.g. water.

The annular knife may further comprise a guide such as a depth gauge hereby making a cutting slit between the annular knife blade and the depth gauge, The angle of the slit determines how deep the knife can cut into art item.

The sensor may be a unit or package of e.g. 5.5×3.8×1.1 mm including one or more of the following features:
a. An absolute orientation sensor, such as an intelligent -axis absolute orientation sensor,
b. A rechargeable button cell,
c. A microcontroller, such as a 64-bit microcontroller,
d. A wireless data transmitter.

The absolute orientation sensor may comprise:
a. An accelerometer, such as a tri-axial accelerometer, and/or
b. A gyroscope, such as a tri-axial gyroscope, and/or
c. A geomagnetic sensor, such as a tri-axial geomagnetic sensor.

The disclosure also relates to a system for manual trimming of meat pieces, the system may comprise:
a. At least one annular knife as described herein,
b. At least one handling area for manual trimming at least one meat piece,
c. At least one outcome illustrating device, such as at least one monitor, located close to said handling area, said outcome illustrating device being capable of showing an outcome relating to a specific meat piece located at the handling area, and where such outcome is relating to thickness of fat present on the meat piece.
d. Optionally, at least one camera, such as a video camera, located close to the handling area, the at least one camera being capable of obtaining at least One image of at least one meat piece being located at the handling area.
e. At least one hit layer thickness determining means being located upstream of the handling area, the fat layer thickness determining means being capable of obtaining data relating to the thickness of fat present on a meat piece preferably without cutting or pricking into the meat piece, the fat layer thickness determining means may comprise at least one data collecting means based on ultrasound e.g. together with a vision system and/or based on X-rays for determining the thickness including variation hereof of a an outer fat layer and/or outer fat regions optionally including a skin layer,
f. At least one processor for processing data and producing an outcome relating to thickness of fat present on a meat piece and where data may he obtained from any of:
   a. by the fat layer thickness determining means,
   b. optionally by the at least one camera,
   c. from the annular knife with a sensor, and/or
   d. from an operator,
g. and the outcome of the processed data is illustrated by the outcome illustrating device, such as showed on a monitor e.g. as at least one image indicating e.g. fat layer thickness of a meat piece.

The disclosure also relates to a method for determining the cutting depth when cutting with an annular knife with a sensor, such as an annular knife as described herein, where a sensor mounted at the knife's solid part determines the absolute position and the orientation of the knife's solid part and determines the correlation between the knife's orientation in relation to the cutting plane and the resulting cutting depth. Preferably the sensor can read a quaternion description of the knife orientation in space.

The disclosure also relates to a method of trimming a meat piece with an annular knife as described herein as well as to use of the annular knife such as for: trimming animal meat pieces, removal of skin front a carcass or from a meat piece, removal of skin from a human, such as cutting thin layers or sections of skin tissue from humans.

### BRIEF DESCRIPTION OF THE DRAWINGS

FIG. 1 illustrates an annular knife with an indication of a possible location for a sensor.

FIG. 2 illustrates the determined cutting depth of an annular knife with a sensor from time=0 to time=10.

FIG. 3 illustrates fat profiles along a meat product.

FIG. 4 illustrates a fat thickness map of a meat piece.

FIG. 5 illustrates a working station fix trimming meat pieces.

### DETAILED DESCRIPTION

An aspect of the disclosure relates to an annular knife comprising at least
a. an annular knife holder,
b. an annular knife blade,
c. a handle or a robot connection unit, and
d. at least one orientation sensor.

Annular knives are generally known as Whizard knives and may be annular knives used for trimming meat e.g. at slaughterhouses, such as a Whizard Trimmer from Bettcher Industries. Such knives or other types of annular knives may equipped with at least one orientation sensor making it possible to determine the absolute orientation of the knife within space and thus making it possible to determine a cutting depth during e.g. trimming of meat pieces.

The sensor of the annular knife may be located at any suitable place of the annular knife, preferably the sensor is mounted at the knife's solid parts, such as within one of the knife's solid parts, e.g. within the handle, within the frame, within the cover or within a thumb support. The sensor's location may be dependent on the design of the knife as well as what the knife should be used for. For cutting meat or trimming meat at abattoirs or other food producing companies the sensor may need to be located in a place where e.g. water, fat and/or other constituents from the meat cannot reach and destroy the sensor.

The annular knife may further comprise a guide such as a depth gauge hereby making a cutting slit between said annular knife blade and said depth gauge. The size of the cutting slit i.e. the distance between the annular knife blade and the depth gauge determines the maximum distance the annular knife can cut into an item such as a meat piece.

The depth gauge may have any design, such as:
i. an annular depth gauge i.e. with an open (non-complete) interior, however the annular depth gauge may be truly annular i.e. be located, along all the part of the annular knife blade which is outside the frame, or the annular depth gauge may be part(annular where they depth gauge is only present along part of the annular knife blade which is outside the frame,
ii. a circular depth gauge i.e. with a solid interior or with apertures in the interior,
iii. a clothoid or partly spiral shaped depth gauge such that the edge of the depth gauge which is closest to the annular knife blade is not within the same distance to the annular knife blade along all the part of the depth gauge, hereby distance between the depth gauge edge and the cutting edge of the knife blade may vary from e.g. 0.5 mm to e.g. 10 mm along the part of the annular knife which is suitable, for being used for trimming/cutting.

With an annular knife with a clothoid or partly spiral shaped depth gauge the operator may use different parts of the knife depending on how thick a fat layer should be removed in different areas of a meat piece as the cutting slit will vary depending on the distance from the knife blade to the depth gauge.

The depth gauge secures the knife only cuts with a certain thickness depending on the angle of the knife, If the knife is not angled in relation to the surface from where material should be cut away the annular knife and the depth gauge are in the same plane and the knife will not cut away any material. When the knife is angled in relation to the surface from where material should be cut away such that the annular knife is closer to the surface than the depth gauge then it is possible to cut away material. The larger the angle is, the deeper the knife may cut, though with limitations due to the depth gauge and dimension of the annular knife.

When trimming meat pieces such as pork loin or pork bellies and meat pieces of comparable sizes i.e. meat pieces which can be handled by a single operator at a handling station the surface of the meat piece may be assumed to be horizontal and hereby the orientation i.e. angling of the annular knife in relation to horizontal indicates the thickness of removed fat. Thickness determination with an annular knife as described herein may also be performed with other surface orientation e.g. vertical, surfaces such as when trimming hanging carcasses e.g. cattle carcasses where the cutting depth is also determined according to the angle between the product surface and the knife plane. Algorithms used by a processor to e.g. determine the cutting depth may take the trimming direction and/or type of material to be cut into, consideration.

The orientation sensor on the annular knife may be capable of determining the position of the knife i.e. of the sensor and the orientation of the knife i.e. how much the angle of the knife is in relation to e.g. horizontal. By mounting a sensor for determining the absolute position and orientation on the knife's fixed part it is possible to determine the relationship between the orientation of the knife in relation to the cutting plane and the resulting cutting depth.

The distance from the cutting part of the annular knife to the depth guide should preferably be known. This distance may be a standard distance when using a new knife, but during use and sharpening of the knife it is exposed to hard wear and the distance between the knife and the depth gauge increases giving an increased cutting depth for a similar angling of the knife when compared to a knife with a smaller distance between the knife blade and the depth gauge. From time to time the distance between the knife and the depth gauge should preferably be determined, this may be done manually e.g. by a ruler or by a camera. The distance can be communicated to a processor, which may include this distance in the calculations when determining the cutting depth.

The annular knife with a sensor may comprise one or more of the following features:
a. An absolute orientation sensor, such as an intelligent 9-axis absolute orientation sensor,
b. A rechargeable button cell,
c. A microcontroller, such as a 64-bit microcontroller, and/or
d. A wireless data transmitter.

The sensor can if desired be built together with a rechargeable button cell, a micro controller and if required together with a wireless data transmitter to function as a wireless determination of the cutting depth as a function of time.

The absolute orientation sensor may further comprise one or more of the following features:
a. An accelerometer, such as a tri-axial accelerometer.
b. A gyroscope, such as a tri-axial gyroscope,
c. A geomagnetic sensor, such as a tri-axial geomagnetic sensor.

Such a sensor can e.g. be made up with a BNO 055 (Bosch Sensortec) absolute orientation sensor which can read out a quaternion description of the knife orientation in space. Other types of sensors can also be used and may also read out to form a quaternion description of the knife orientation in space.

The sensor may further comprise one or more of the following features:
a. The sensor is a System in Package (SiP),
b. The sensor has a first dimension of less than 10 mm, e.g. less than 8 mm, such as less than 6 mm, such, as about 5 mm,
c. The sensor has a second dimension of less than 4 mm, e.g. less than 5 mm, such as less than 4 mm,
d. The sensor has a third dimension of less than 4 mm, e.g. less than 3 mm such as less than 2 mm, e.g. about 1 mm,
e. Sensor fusion algorithms, such as algorithms capable of determining three-dimensional rotation,
f. Software capable of communicating three-dimensional rotation, such as Quaternion communication,
g. Other features of the sensor may be one or more of the features:
   i. 9-axis sensor fusion algorithms,
   ii. Fast in-use background calibration of all sensors and calibration monitor,
   iii. Enhanced magnetic distortion detection and suppression,
   iv. Real-time motion tracking due to built-in group delay compensation,
   v. Gyroscope drift cancellation,
   vi. Support of 6-axis based applications,
   vii. Support of various power modes for switching on/off sensors and algorithm modules.

The sensor may be a small unit i.e. a System in Package comprising one or more of the features mentioned herein and the sensor may be capable of being mounted in or at the knife's solid parts and capable of determining e.g. the absolute position and angling of the knife and capable of communicate data wireless to a processor located outside the knife.

Another aspect of the disclosure relates to a system for manual trimming meat pieces, the system may comprise:
a. An annular knife with a sensor, such as an annular knife as described elsewhere herein,
b. A handling area for manual trimming at least one meat piece, the handling area is preferably organized such that the annular knife can be used at the handling area.
c. At least one outcome illustrating device, such as at least one monitor, located close to the handling area, the outcome illustrating device being capable of showing an outcome relating to a specific meat piece located at the handling area, and where such outcome is relating to thickness of fat present on the meat piece,
d. Optionally, at least one camera located close to the handling area, the at least one camera being capable of obtaining at least one image of at least one meat piece being located at the handling area,
e. A fat layer thickness determining means may be located upstream of the handling area, the fat layer thickness determining means may be capable of obtaining data relating to the thickness of fat present on a meat piece preferably without cutting or pricking into the meat piece, the fat layer thickness determining means may comprise at least one data collecting means based on ultrasound e.g. together with a vision system and/or may be based on X-rays for determining the thickness including variation hereof of a an outer fat layer and/or outer fat regions,
f. A processor for processing data and producing an outcome relating to thickness of fat present on a meat piece and where data may be obtained:
   i. by the fat layer thickness determining means.
   ii. optionally by the at least one camera, and
   iii. front the annular knife with a sensor,
and the outcome of the processed data may be illustrated by the outcome illustrating device, such as showed on a monitor e.g. as at least one image indicating e.g. fat layer thickness of a meat piece.

The annular knife with a sensor is preferably a knife driven by electricity, thus an electric installation is preferably present at the handling area,

An outcome illustrating device may be at least one monitor where the outcome can be illustrated by an image from which an operator may retrieve information in respect of the thickness of the fat layer i.e. in such a system the outcome is not projected towards the meat piece. An outcome illustrating device may also be a device projecting an outcome towards a meat piece which an operator is ready to trim or is trimming. Such outcomes projected towards a meat piece may be an image including lines and/or colors or it may be figures or simple lines projected onto the meat piece. An outcome illustrating device may also be a head mounted device or smart glasses which could show the outcome to an operator e.g. instead of showing the outcome at a monitor. The head mounted device or smart glasses could also be used for augmented reality where the meat piece in the handling area could be overlaid with the outcome produced in the system and this image could be shown in the head mounted device or in the smart glasses.

The outcome may be a fat thickness map or image which can be shown on a monitor and/or projected on the meat piece. A fat thickness map or image may illustrate the actual thickness of fat on a meat piece to be trimmed or it may illustrate the areas with a thickness of fat above one specific threshold or several different thresholds.

The fat thickness map may be an image with colors e.g. blue, green, yellow, orange and red where each color indicates a range of measured fat thicknesses or each color indicates how much fat should be removed in the area, as an alternative only areas with fat indicated by red color should be trimmed. As an example a fat thickness map is produced and the monitor may show the map or the corresponding fat side of a meat piece may be overlaid with a color coding with a nonlinear transformation where the product recipe dictates a fat cover of not more than e.g. 7 mm: Blue color indicate thicknesses below 7 mm so no fat trimming in the blue areas are required. The range between 7 mm and 15 mm is indicated in green (e.g. 7 to 11 mm) to yellow (e.g. 11 to 15 mm) colors and orange (e.g. 15 to 19 mm) to red (e.g. above 19 mm) accounts for areas with a fat thickness of above 1.5mm. The operator for this particular product is hereby informed where to trim and in coarse measures how much fat it is needed to remove by trimming. The color system may be adapted to the company e.g. in the number of used colors and/or the meaning of each color.

At least one camera may be located close to the handling area, the at least one camera may be capable of obtaining at least one image of at least one meat piece being located at the handling area. This image may be used to inform the system where the meat piece is located and how it is positioned and hereby making the system capable of showing the outcome in the correct position either on a monitor or projected towards the meat piece. The at least one camera may also be used to obtain information in respect of where the operator cuts away fat and/or other constituents of the meat piece and with the calculated depth of the cut based on the sensor data retrieved from the annular knife the system can calculate how much fat is left on the meat piece in the area where the operator has just cut away material. The information may be used to adjust the outcome and show a real time outcome of the amended fat layer on the monitor or in the information projected towards the meat piece. Hereby the operator is informed whether more fin should be removed in the treated area of the meat piece.

The at least one camera may also obtain images of the annular knife and especially of the area of the annular knife and the depth gauge. Data from such images may be communicated to the processor, and hereby the processor may calculate the distance between the annular knife and the depth gauge and compensate for the wearing of the knife in the determination of the coning depth of the annular knife.

A fat layer thickness determining means may be located prior to the handling area to determine the fat layer thickness of meat pieces. The fat layer thickness determining means may use ultrasound e.g. together with a vision system and/or may use X-rays to determine the thickness and variation of the thickness of fat present on a meat piece. X-rays may be used by a CT-scanner scanning the meat piece. 3D maps may be made from CT scanning of the raw material e.g. meat pieces, The image stacks (tomograms) from the CT scanner, may be stored and form the input to a segmentation program, classifying the tissue density into three classes: meat, fat and bone by simple thresholding. From such 3D maps 2D maps (fat thickness maps) can be created of the thickness of fat on e.g. one side of the scanned material.

When trimming meat e.g. at abattoirs the carcasses are usually cut into meat pieces where the fin and/or skin to be removed is located on one side of the meat piece, hereby only one side of a meat piece should be analyzed in respect of fat thickness.

A processor of the system may retrieve any data or information obtained by the devices in the system and/or an operator may communicate data to the processor. The processor may thus be connected by wire or wireless to any of the devices in the system. The processor may use some or all of the retrieved data or information to produce an outcome or an amended outcome such as a real time outcome, and the processor may communicate this outcome to e.g. an outcome illustrating device.

In the system as described herein:
a. the outcome produced by the processor may be communicated to the outcome illustrating device, such its a monitor, and/or
b. the outcome may be shown on or by the at least one outcome illustrating device, such as shown on a monitor, when the meat piece from where data is obtained, is located in the handling area, and/or
c. based on data obtained from the annular knife during trimming the processor may determine how much fat and/or meat is cut away during the trimming of the meat piece, and/or
d. the at least one camera may obtain at least one image of the meat piece located in the handling area, such as to determine where the annular knife cuts away fat and/or meat from the meat piece, and/or
e. data from the annular knife and from the at least one camera may be processed real-time by a processor and based on data from the fat layer thickness determining means the at least one outcome on the outcome illustrating device may be adjusted to indicate the current fat layer thickness of an outer fat layer and/or outer fat regions.

A further aspect of the disclosure relates to system for automatic trimming meat pieces, the system may comprise:
a. An annular knife with a sensor, such as an annular knife as described elsewhere herein and comprising a robot connection unit making it possible to mount the annular knife on a robot,
b. A handling area for automatic trimming at least one meat piece, the handling area is preferably organized such that the annular knife can be used by a robot t the handling area,
c. Optionally, at least one camera located close to the handling area, the at least one camera being capable of obtaining at least one image of at least one meat piece and/or of the location of the annular knife holder in relation to the meat piece being located at the handling area,
d. A fat layer thickness determining means may be located upstream of the handling area, the fat layer thickness determining means may be capable of obtaining data relating to the thickness of fat present on a meat piece preferably without cutting or pricking into the meat piece, the fat layer thickness determining means may comprise at least one data collecting means based on ultrasound e.g. together with a vision system and/or based on X-rays for determining the thickness including variation hereof of a an outer fat layer and/or outer fat regions,
e. A processor for processing data and producing an outcome relating to thickness of fat present on a meat piece and where data may be obtained:
   i. by the fat layer thickness determining means,
   ii. optionally by the at least one camera, and
   iii. from the annular knife with a sensor,
and the outcome of the processed data is forwarded to the robot which is then programmed to cut away fat in selected areas of the meat piece and with a calculated depth.

Some of the functions described for the system with manual trimming of meat pieces may also be present for a system based on at least one robot to trim meat pieces such function may be e.g. the real time trimming determination.

The disclosure further relates to a method for determining the cutting depth when cutting with an annular knife with a sensor, such as an annular knife as described herein, where a sensor mounted at the knife's solid part determines the absolute position and the orientation of the knife's solid part and determines the correlation between the knife's orientation in relation to the cutting plane and the resulting cutting depth.

The sensor register the movement variation of the annular knife in all directions and algorithms can use this data to determine the cutting depth of the knife.

In the method the sensor may be capable of read a quaternion description of the knife orientation in space. A processor may retrieve this information and calculate the cutting depth of the annular knife.

An example of cutting depth in relation to time is shown in FIG. 2.

Concurrently with that the blade of the knife is subjected to wear or is sharpened and becomes smaller the distance between the fixed guide and the knife's cutting edge is determined again e.g. with a video camera or a liner to be able to compensate in the transformation between orientation and cutting depth.

The other physical parameters in the sensor can also monitor degree of wear of the knife e.g. alert when a tooth from time to time break off, such as if a tooth breaks off the driving gear wheel, or the blade is partially broken e.g. is split.

Measuring of cutting depth with a sensor as described herein can be used in different situations such as at an abattoir e.g. when dressing or trimming meat pieces, such as removal of hide and/or fat from meal pieces.

The sensor can also monitor if the operator performs unnecessary and/or incorrect movements and thus reduce the risk of injury due to excessive straining as a consequence of the cutting process.

A further aspect of the disclosure relates to a method of rimming a carcass or meat piece e.g. trimming with an annular knife as described herein, the method may comprising the steps of
a. Obtaining a carcass or meat piece with an outer fat layer and/or outer fat regions, the fat may be covered with skin,
b. Obtaining data from the carcass or meat piece in respect of fat thicknesses of the outer fat layer and/or outer fat regions, where obtaining the data may be based on ultrasound e.g. together with a vision system or X-ray analysis,
c. Generating an outcome of the obtained data relating to different fat thicknesses present as an outer fat layer and/or outer fat regions on the meat piece, the outcome may be a visual outcome, this outcome may be capable of illustrating where fat should be removed from the carcass or meat piece and/or illustrating the thicknesses of an outer fat layer and/or outer fat regions on the carcass or meat piece,
d. At a handling area combining the presence of the carcass or meat piece with the outcome hereby indicating by or at an outcome illustrating device where fat should be removed from the carcass or meat piece,
e. With a knife, such as the annular knife described herein, cut away fat from areas on the carcass or meat piece where the thickness is above a pre-determined thickness.

Any carcass or meat piece may be trimmed with the annular knife as described herein. Such carcass or meat piece may originate from e.g. pigs, cattle, cows, deer, sheep, goats, and poultry such as chicken, preferably livestock raised animals. Preferred is trimming of meat pieces which have a surface that, is substantially horizontal or vertical during the trimming process. Such meat pieces may be pork neck, shoulder, loin, belly and ham, cattle/cow rib-parts, brisket, short rib, loin, short loin, full rump, culotte, and cuvette.

The disclosure also relates to use of an annular knife as described herein. Such use can be for trimming meat or meat pieces which is at least intended to be used as food or feed.

The annular knife as described herein may also be a dermatome i.e. a hand-held surgical instrument used by a physician or a medical professional for cutting thin layers or sections of skin tissue from humans. A dermatome may be used for e.g. removal of skin from a human patient, skin debriding (removal of burned skin tissue), tumor/lesion removal and breast reduction. When the annular knife as described herein is a dermatome the method of determining the cutting depth may especially be useful for removal of burned skin tissue, tumor/lesion removal, breast reduction and for cutting thin layers of skin where the thickness is important and for cutting thicker layers of skin where all the layers of skin should be included in the section.

The use of the annular knife as described herein may be performed at an abattoir or another food producing company when trimming meat pieces intended to be used for food or feed. For medical purpose the use may be at hospitals or surgical clinics.

Use of the annular knife as described herein or of an annular knife with similar function may be performed according to the method for determining the cutting depth as described herein and optionally in a system for trimming meat pieces as described herein.

The use in a method of trimming at least one meat piece, as described herein may be performed by including a method for determining the cutting depth as further described herein.

The annular knife with a sensor as described herein may also be used to determine whether an operator is exposed to repetitive strain injury (RSI) while during cutting making movements which are very similar to each other. This may be observed e.g. from the orientation of the annular knife. An alarm may be included in the system warning the operator and hereby request the operator to make variations in the movement pattern when cutting.

The sensor of the annular knife may comprise an accelerometer which may register the vibrations of the annular knife. A processor may analyze the vibrations and may determine whether changes in the vibration's frequency spectrum are due to wear of the wire driving the knife and/or due to wear of the teeth or one or more broken teeth e.g. on the knife blade, on the knife holder or at other locations in the knife. An alarm may indicate the wear and e.g. that the knife blade or knife holder should be replaced.

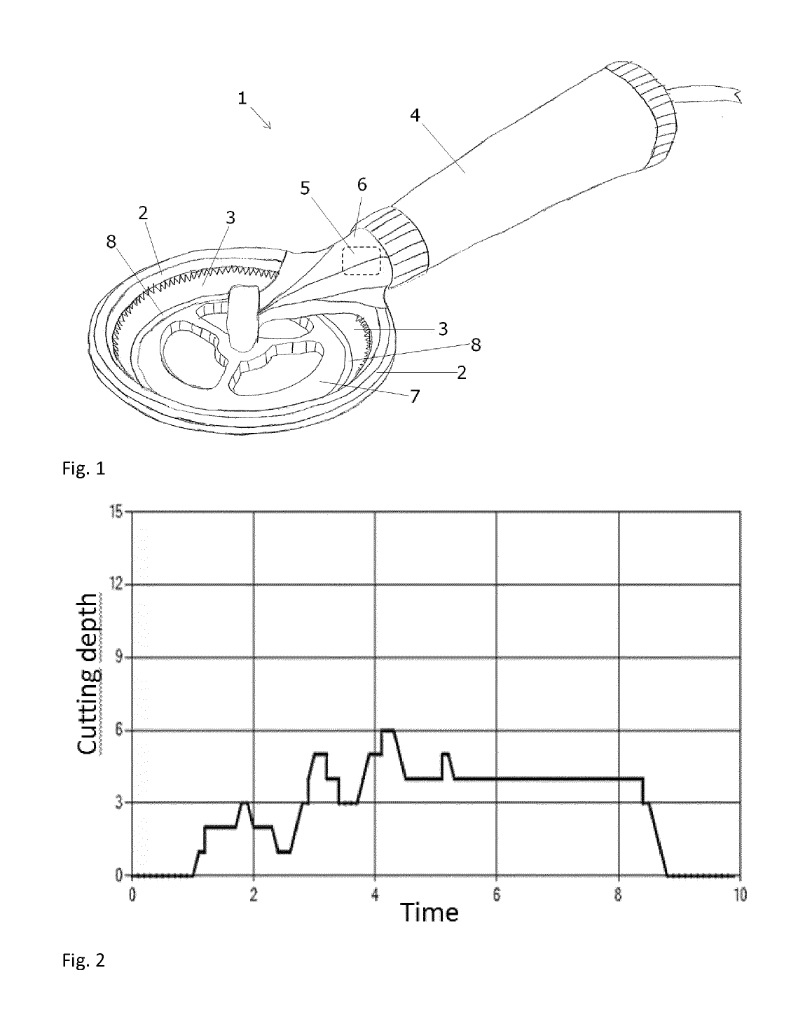

FIG. 1 illustrates an annular knife (1) with an indication of a possible location for a sensor (5), The annular knife (1) comprises an annular knife holder (2) for holding an annular knife blade (3). The illustrated annular knife (1) is an electrical knife for manual use and has a handle (4), wherein a sensor (5) may be located, however the sensor (5) is in this annular knife located in the frame (6). Further the annular knife has a depth gauge (7) which together with the annular knife blade (3) makes an opening which functions as a cutting slit (8) where the size of the cutting slit (8) determines the maximum cutting depth of the annular knife (1).

FIG. 2 illustrates the determined cutting depth of an annular knife with a sensor from time=0 to time=10 (e.g. seconds) or position of the meat piece sectioned into 10 parts. The cutting depth was calculated from data obtained from a sensor located on an annular knife when cutting a more or less horizontal surface, Such data comprises actual location and orientation of the annular knife e.g. angling of the knife. From time=0-1 the annular knife is not angled and the cutting depth is 0 then the angle between the annular knife and the surface is increased in steps to reach a cutting depth of 3 mm, then the angling is stepwise decreased to a cutting depth of 1 mm, increased and decreased a number of times and from just after time 5 to just after time=8 the knife is held at a constant angling with a cutting depth of about 4 mm, whereafter the angling of the knife is decreased to reach a cutting depth of 0 i.e. no angling. Similar graphs could be obtained with cutting depth as a function of position on a meat piece.

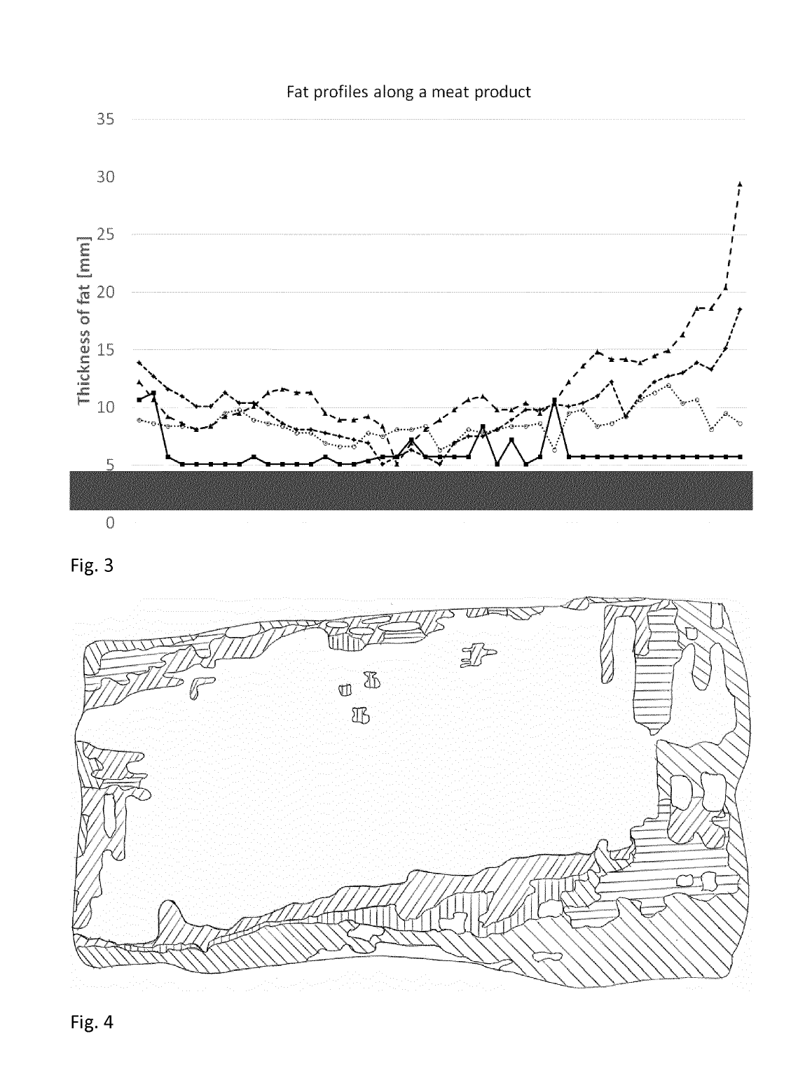

FIG. 3 illustrates fat profiles along a loin piece from a pig. The left end of the graphs is the neck-end of the meat piece and the right end of the graphs is the hip end of the meat piece. Different types of lines illustrate different substantially parallel lines along the loin. Before determining the fat thickness the skin was removed mechanically. Thickness of the fat was determined along tear longitudinal lines of the loin with a CT-scanner using X-ray determination. As can be seen from the graphs the fin thickness is at least 5 mm along all four lines but otherwise vary in thickness indicating that different amount of fat has to be cut away to obtain a loin with e.g. a fat thickness of no more than 7 mm. In some areas no fat should be removed in other areas e.g. 8-10 mm of fat should be removed and in one end of the loin 21 mm of fat should be removed to reach a thickness of 7 mm.

FIG. 4 illustrates a fat thickness map of a belly piece from a pig. When in use the image is usually in color and different colors may indicate the actual thickness of the fat layer or the amount of fat which an operator should remove. The skin of the belly piece was mechanically removed before determining the flit thickness at the belly piece. The live different indications in the image are none (non-shaded areas) or shading lines in four different directions, which may correspond to the following colors in a color image: ( )=blue; (///)=green; (|||)=yellow; (≡)=orange; (\\\) red. In such a color image the blue color may indicate areas with less fat followed by increasing thickness illustrated by green, yellow and orange and the thickest fat may be illustrated by red. The colors may indicate the actual thickness of the fat layer or may indicate how much fat an operator or robot should remove from the meat piece to obtain a fat layer of a pre-determined thickness.

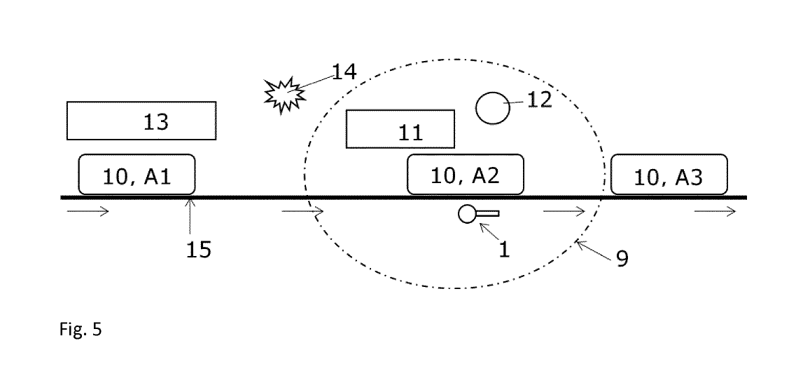

FIG. 5 is a schematic illustration of a production line including a working station (handling area (9)) for trimming meat pieces at an abattoir or other food producing company. Meat pieces (10, A1, A2 and A3) are transported by a conveyor belt (15) moving in the direction indicated by the arrows below the conveyor belt (15). The meat piece (10) is first analyzed to obtain data of the thickness of the fat layer, this happens when the conveyor belt (15) transports the meat piece (10, A1) past a fat layer thickness determining means (13) such as a CT-scanner or a system using ultrasound e.g. together with a vision system. Obtained data is processed in a processor (14) and the outcome is illustrated on or by an outcome illustrating device (11) e.g. a monitor in the handling area (9) where an operator is ready to trim the meat piece. In the handling area (9) a camera (12) may be located and the annular knife (1) with a sensor which is handled by the operator. The handling area (9) where the operator trims the meat can be located next to the conveyor belt (15) such that the operator handles the meat piece (10, A2) on a stationary table (not shown). A monitor may show a colored image (such as a fat thickness map as shown in FIG. 4 though in colors) where the different colors indicate how much fat should be removed in the different areas of the meat piece (10). When trimmed the meat piece (10, A3) can be transported by the conveyor belt (15) e.g. to a packaging station (not shown).

### LIST OF REFERENCE SIGNS

In the figures, identical structures, elements or parts that appear in more than one figure are generally labeled with the same numeral in all the figures in which they appear.

1. Annular knife

2. Annular knife holder

3. Annular knife blade

4. Handle

5. Sensor

6. Frame

7. Depth gauge

8. Cutting slit

9. Handling area

10. Meat piece

11. Outcome illustrating device/Monitor

12. Camera

13. Fat layer thickness determining means

14. Processor

15. Conveyor belt

### ITEMS

1. Circular knife with a sensor for determining the cutting depth.
2. Circular knife according to item 1, wherein the sensor comprises one or more of the following features:
   a. An absolute orientation sensor,
   b. A rechargeable button cell,
   c. A micro controller,
   d. A wireless data transmitter.
3. Circular knife according to item 2, wherein the orientation sensor is of the type BNO 055 from Bosch Sensortec.
4. Circular knife according to any of the items 1 to 3, wherein the sensor is mounted at the knife's solid parts.
5. Method for determining the cutting depth of a circular knife where a sensor determines the absolute position of the knife blade and the orientation of the knife's solid part and hereby determines the correlation between the knife's orientation in relation to the cutting plane and the resulting cutting depth.
6. Method for determining the cutting depth of a circular knife where a sensor mounted at the knife's solid part determines the absolute position and the orientation of the knife's solid part and hereby determines the correlation between the knife's orientation in relation to the cutting plane and the resulting cutting depth.
7.Method according to any of the items 5 to 6, where the sensor can read a quaternion description of the knife orientation in the space.

What is claimed is:

1-14. (canceled)

15. An annular knife comprising:
an annular knife holder;
an annular knife blade;
a handle or a robot connection unit; and
an orientation sensor.

16. The annular knife according to claim 15, wherein:
said sensor is mounted within a solid part of the annular knife, wherein said solid part comprises one or more of: the handle, a frame, or a thumb support.

17. The annular knife according to claim 15, wherein:
said annular knife further comprises a depth gauge forming a cutting slit between said annular knife blade and said depth gauge.

18. The annular knife according to claim 15, wherein the sensor comprises one or more of; an absolute orientation sensor, a rechargeable button cell, a microcontroller, or a wireless data transmitter.

19. The annular knife according to claim 18, wherein said absolute orientation sensor comprises one or more of: an accelerometer, a gyroscope, or a geomagnetic sensor.

20. The annular knife according to claim 15, wherein the sensor comprises a first dimension of less than 10 mm, a second dimension of less than 6 mm, and a third dimension of less than 4 mm.

21. The annular knife according to claim 15, wherein the sensor comprises a System in Package.

22. The annular knife according to claim 15, wherein the sensor is configured to execute one or more of: a sensor fusion algorithm or software configured to communicate three-dimensional rotation.

23. The annular knife according to claim 15, wherein the annular knife is configured for one or more of: trimming an animal carcass, trimming an animal meat piece, removing skin from a carcass, removing skin from a meat piece, removing skin from a human patient, performing skin debriding on a human patient, removing a tumor or lesion from a human patient, or performing breast reduction on a human patient.

24. A system for manual trimming meat pieces, said system comprising
an annular knife comprising an annual knife holder, an annular knife blade, and a handle or a robot connection unit;
a handling area configured for manual trimming a meat piece;
an outcome illustrating device located in a vicinity of said handling area said outcome illustrating device being configured to show an outcome relating to a specific meat piece located at the handling area, wherein said outcome relates to a thickness of fat present on said meat piece,
a fat layer thickness determining device located upstream of said handling are said fin layer thickness determining device being configured to obtain data relating to the thickness of fat present on said meat piece, wherein said fat layer thickness determining device is configured to determining a thickness of an outer fat layer or an outer fat region of said meat piece; and
a processor configured to process data and produce an outcome relating to said thickness of flit present on said meat piece;
wherein said data is based at least in part on one or more of: said fat layer thickness determining device, a camera, said annular knife, or an operator; and
wherein the outcome of said processed data is illustrated by said outcome illustrating device.

25. The system according to claim 24, wherein said camera comprises a video camera located in said vicinity of said handling area, said video camera being configured to obtain an image of said meat piece located at said handling area.

26. The system according to claim 25, wherein:
said outcome produced by said processor is communicated to said outcome illustrating device;
said outcome is shown on or by said outcome illustrating device when said meat piece is located in said handling area;
said processor determines an amount of fat or meat removed from said meat piece during a trimming of said meat piece based on data obtained from said annular knife;
said camera obtains said image of said meat piece, said image showing where the annular knife removes fat or meat from said meat piece,
data from said annular knife and from said camera is processed real-time by said processor based on data from said fat layer thickness determining device; and
said outcome on said outcome illustrating device is adjusted to indicate a current fat layer thickness of an outer fat layer or an outer fat region, or to indicate how much fat is to be removed from said meat piece.

27. A method for determining a cutting depth when cutting with an annular knife, comprising:
determining, by a sensor mounted at a solid part of said annular knife, an absolute position and an orientation of said, solid part of said knife;
determining a correlation between an orientation of said annular knife in relation, to a cutting plane; and
determining said cutting depth based at least in part on said orientation of said annular knife in relation to said cutting plane.

28. The method according to claim 27, where said sensor is configured to read a quaternion description of said orientation of said annular knife in space.

29. The method according to claim 27, further comprising:
using said annular knife, based at least in part on said cutting depth, to perform one or more of: trimming an animal carcass, trimming an animal meat piece, removing skin from a carcass, removing skin from a meat piece, removing skin from a human patient, performing skin, debriding on a human patient, removing a tumor or lesion from a human patient, or performing breast reduction on a human patient.

30. A method of trimming a meat piece using an annular knife, comprising:
obtaining a meat piece comprising an outer fat layer or an outer fat region;
obtaining data corresponding to a fat thickness of said outer fat layer or said outer fat region of said meat piece, where obtaining said data is based at least in part on an ultrasound analysis or an X-ray analysis of said meat piece;
generating an outcome of said obtained data relating to different fat thicknesses present in said outer fat layer or said outer fat region of said meat piece;
indicating, based at least in part on said outcome, a fat removal location on said meat piece using an outcome illustrating device in a vicinity of a handling area of said meat piece;
removing fat from said fat removal location on said meat piece;
wherein said thickness of said outer fat layer or said outer fat region is above a threshold thickness at said fat removal location.
